(19) United States
(12) Patent Application Publication
(10) Pub. No.: US 2006/0048051 A1
(43) Pub. Date: Mar. 2, 2006

(54) Method for rendering formatted content on a mobile device

(75) Inventor: Mihal Lazaridis, Waterloo (CA)

Correspondence Address: SIM & MCBURNEY, 330 UNIVERSITY AVENUE, 6TH FLOOR, TORONTO, ON, M5G 1R7, CA

(73) Assignee: Research in Motion Limited, Waterloo (CA)

(21) Appl. No.: 10/924,795

(22) Filed: Aug. 25, 2004

(51) Int. Cl. G06F 17/21; G06F 17/24; G06F 15/16

(52) U.S. Cl. 715/517; 715/513; 715/526; 715/501.1; 709/203

(57) ABSTRACT

A method for transmitting formatted content to a mobile device having a small display screen comprises retrieving a page of formatted content, rendering the page as a graphic such as a JPEG that is sized for display on the small display screen, and transmitting the graphic to the requesting device for display. Hyperlinks are collected and sent with the graphic and are presented as menu options on the device for selection by a user. The user may then request a zoom-in to a portion of the graphic and have a corresponding portion of the page transmitted to the device. The returned web page portion operates as a typical formatted content page, permitting the user to read the contents, select a hyperlink or enter data into a form. A method for displaying a large graphic files on a mobile device having a small display screen comprises requesting the graphic file from a server, in response to the request, receiving the graphic file scaled for display and an identification of portions of the graphic file; displaying said graphic file and an overlaid grid corresponding to said identification of portions of said graphic file. Using the grid, a portion of the graphic file is selected and requested from the server, received and displayed.

### FIELD OF THE INVENTION

The following is directed in general to displaying content on mobile devices, and more particularly to a method for displaying formatted and graphic content on mobile devices having a small screen.

### BACKGROUND OF THE INVENTION

Mobile devices are becoming increasingly popular for business and personal use due to a relatively recent increase in number of services and features that the devices and mobile infrastructures support. Handheld mobile devices, sometimes referred to as mobile stations, are essentially portable computers having wireless capability, and come in various forms. These include Personal Digital Assistants (PDA), cellular phones and smart phones. While their reduced size is an advantage to portability, these mobile devices suffer accordingly from very small user interfaces and, in particular, viewing screens.

One of the services provided by mobile devices and their supporting infrastructures is access to IP networks, and in particular the ability to behave as an HTTP (Hyper Text Transfer Protocol) web client to retrieve and display web pages that have been composed using a markup language such as HTML. Web pages composed with HTML are, however, generally designed for large viewing screens having at least 640×480 pixels, such as those incorporated into desktop computers and laptops. There are provisions available for programs embedded in HTML to detect client screen size and adjust the display of data accordingly. However, it is often extremely difficult for a mobile device to process and render received HTML data effectively on a small screen, because the mobile device must choose which aspects of the HTML data are to be rendered using the limited choice of pixels and which are to be excluded.

Besides HTML, several other formatting languages are available for use in addressing different formatting needs, each having different processing requirements. For instance, it is common practice to use XML to define a formatting method for all Microsoft® Word, Power Point and Adobe documents, etc. Such formatting languages are well known in the art of computer science, starting with SCRIPT, Roff, Nroff, Troff, SGML, GML, and moving towards HTML, XML, HDML, WML and all the other languages that use a specific syntax to display, format and manipulate a set of text that is being conveyed to a user. They can also be called ‘mark up’ languages as they place tags in the text to allow it to be rendered. Alternatively, XML, SGML and GML define a method to have a separate file that defines the formatting of the data, without directly damaging the original text.

Attempts have been made to provide mobile devices having small screens with formatted content, without requiring the devices to choose which elements of the data should be rendered. As stated above, the alternative protocols and display standards, such as Handheld Device Markup Language (HDML) (presently known as the Wireless Markup Language (WML) of the Wireless Access Protocol or WAP) are available to provide content to devices having reduced screen size, processing and bandwidth capacity. Content providers maintain their content in two different formats, and serve one or the other of the formats depending on the type of client requesting. This dual-format approach, however, requires significantly greater effort on the part of the content provider and additional storage space. Furthermore, content providers are obliged to maintain intelligent servers for detecting the type of client in order to determine which of the formats to serve. Just as the proponents of WML attempted to solve the problem the explosion in the use of XML for formatting every piece of data and for use in data inter-exchange between systems is further complicating the problem.

A method used for providing mobile devices with web content formatted according to HTML is to, in real-time, transcode the HTML content into WML content and, in turn, serve the WML content. To do so also requires a WAP server and a somewhat sophisticated HTML-to-WML transcoding filter. The end result is rarely predictable, however, since perfect transcoding of the rather loose and flexible HTML standard is very difficult to achieve. Another problem to surmount is that HTML pages often include embedded programs designed to be interpreted by the client (such as client-side JavaScript) for display purposes that are often lost during transcoding because they cannot be executed by a WML browser. The above-described difficulties associated with this transcoding approach makes the real-time transcoding of HTML pages into WML an unwieldy process that is of limited benefit. The same is true, in general, of transcoding any formatting language.

As would be understood, viewability of large graphic files for maps or other pictures can be frustrating for users also. This is because either the user typically gets merely a scaled down version of the picture, or is left with having to pan and scan the picture if it does not fit fully on their screen.

### SUMMARY OF THE INVENTION

According to an aspect of the invention, a requested formatted language page (document) is retrieved and rendered as a graphic (such as a JPEG, GIF etc.) sized for display by a requesting device (requester). The graphic is, in turn, served to the requesting device in response to a request.

Because the page is retrieved and rendered as a graphic prior to being transmitted to the requester, the requestor need not handle formatting decisions. This advantage is particularly useful for mobile devices having small display screens because the device need only handle the display of a graphic, rather than process a formatted page of data and choose what is or is not to be rendered. An additional benefit is that the multiple requests normally executed by the client (as in the case with an HTML document) to completely render a single page (to collect constituent graphics, text, frames and the like for the page) are made by the transmitting party, and not through the reduced-bandwidth client-server mobile connection. Furthermore, content need not be arranged in a manner that is particular to the display screen used by the requester, other than its size, either at publication time as required by the dual-format approach or at request time as required by the transcoding approach. In addition, client-side programs embedded in the formatted page can be executed because the page is executed as though it were on a client, prior to rendering as a graphic.

According to an aspect of the invention, a method for transmitting formatted data to a requestor comprises retrieving a page of formatted data; rendering the page as a graphic sized for display by the requester; and in response to a request from the requester for the page, transmitting the graphic to the requestor.

According to another aspect of the invention, a method of displaying formatted data comprises requesting a page of formatted data from a server; in response to the request, receiving a graphic rendering of the page from the server; and displaying the graphic.

According to yet another aspect of the invention, a method of transmitting a graphic file to a requestor comprises retrieving a graphic file; scaling said graphic file for display by said requester; subdividing the scaled graphic file into portions; and in response to a request from said requestor for said graphic file, transmitting the scaled graphic file and an identification of said portions to said requestor.

According to a further aspect of the invention, a method of displaying a graphic file comprises requesting said graphic file from a server; in response to said request, receiving said graphic file scaled for display and an identification of portions of said graphic file; and displaying said graphic file and an overlaid grid corresponding to said identification of portions of said graphic file.

These together with other aspects and advantages, which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

A detailed description of the preferred embodiment is set forth in detail below, with reference to the following drawings, in which:

FIG. 1 is a block diagram of a network environment in which the preferred embodiment may be practiced;

FIG. 2 is a block diagram of the basic components of the preferred embodiment of the invention;

FIG. 3 is a pictorial view showing exemplary steps of web content retrieval according to the preferred embodiment of the invention;

FIG. 4a is a block diagram showing a way of enabling a user to select embedded links or download particular aspects of web content;

FIG. 4b is a block diagram showing an alternative way of enabling a user to select embedded links or download particular aspects of web content; and

FIG. 5 is a pictorial view showing steps of web content retrieval according to an alternate embodiment of the invention.

### DETAILED DESCRIPTION OF THE PREFERRED EMBODIMENT

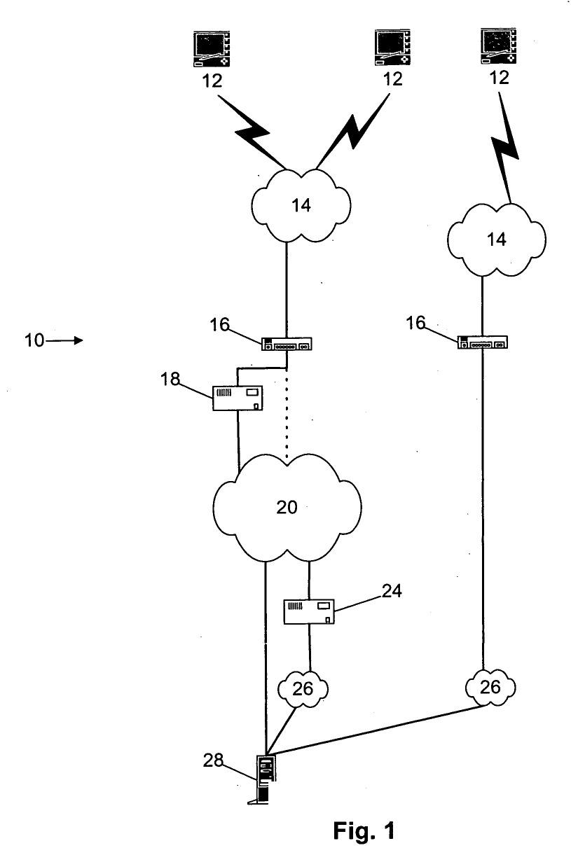

With reference to FIG. 1, a block diagram of a network environment 10 in which the preferred embodiment of the invention may be practiced is shown. Network environment 10 includes mobile stations 12 communicating via a wireless network 14 to server 28. While only one server 28 is shown for illustration purposes, it would be understood that network environment 10 could have many such servers. Server 28 can host web sites or graphic download sites, providing access to picture files such as JPEG, TIFF, BMP, PNG, SGI, MP4, MOV, GIF, SVG or other such format. As would be understood by one of ordinary skill in the art, wireless networks 14 might include GSM/GPRS, CDPD, TDMA, iDEN Mobitex, DataTAC networks, or future networks such as EDGE or UMTS and broadband networks like Bluetooth-and variants of 802.11.

A connection to a fixed service requires special considerations, and may require special permission as authorized through a Network Access Point (NAP) 16. For generic services, such as web access, a proxy-gateway or Network Address Translator (NAT) 18 may be provided so that a network operator can control and bill for the access. NATs 18 enable management of a limited supply of public Internet addresses for large populations of wireless mobile stations. Solutions offered by a proxy-gateway or NAT 18 can require a complex infrastructure and thus may be managed by a value-added service providers (VASPs), which provide, for instance, WAP gateways, WAP proxy gateway solutions, multi-media messaging servers (MMS) and Internet Multi-Media Services (IMS).

Network operators may also place picture file services directly into network environment 10 by connection directly to NAP 16.

Private Intranet services 26 also connected to Internet 20 may require their own Private Intranet Proxy Gateway 24 for accessing content on server 28. Such private services might include WML access to corporate mail systems, HTML access to CRM databases, or any other services that deliver information as formatted data with links and URLs embedded. As shown, it is possible that a private service 26 may be connected directly to wireless network 14, as opposed to connected via Internet 20.

Used throughout this document for the purpose of describing the preferred embodiment is the example of rendering a web page based on HTML. At the time of writing this document HTML is the prevalent formatting language used on the Internet, but the use of XML is also gaining ground significantly. It will be understood that the use of HTML and web page concepts throughout this document is not meant to limit the graphic rendering method to simply this formatting language only.

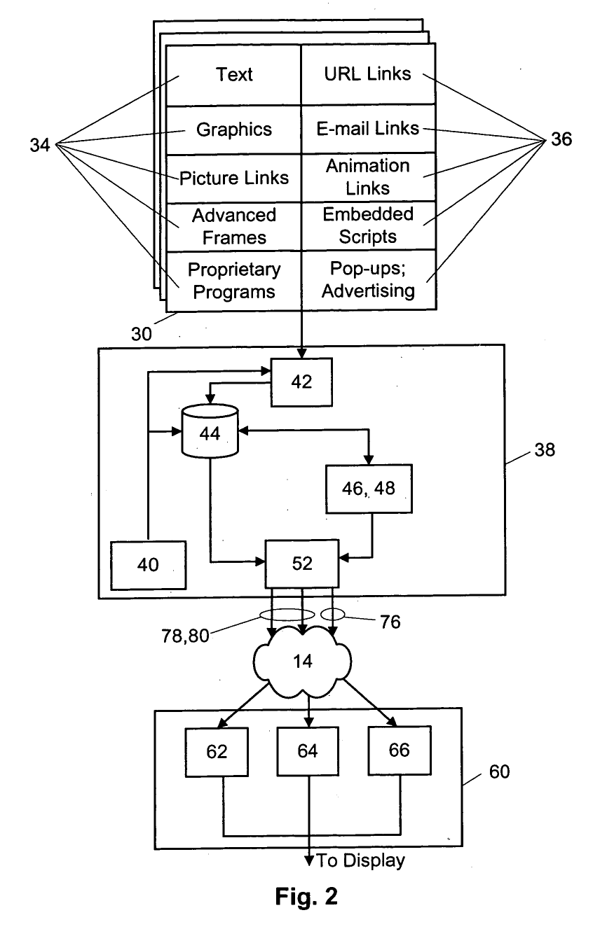

With reference to FIG. 2, a block diagram of the basic components of the preferred embodiment of the invention is shown. Web content 30, which may consist of formatted data with links and URLs such as HTML or WML, is stored at least partly in server 28. A Content Delivery Server 38 resides in proxy gateway/NAT service 18 and private Intranet proxy gateway 24. Upon receipt of a request from a requestor such as a mobile device 12 via receiver 40, content retriever 42 of Content Delivery Server 38 retrieves a page of web content 30 from server 28 and stores the page in database 44. As would be understood by one of ordinary skill in the art, a single web page retrieved via HTTP often includes additional directives for initiating HTTP requests to collect constituent elements including frame data, graphics and banners. Content retriever 42 also collects the web page's constituent elements and stores everything in mutual association into database 44. When this is complete, graphic converter 48 collects the web page with its constituent elements from database 44 and renders the entire web page as a graphic 80 such as a JPEG (or other suitable format such as GIF) sized (scaled) for display on mobile device 12. A processor 46 collects hyperlinks 78 from the page of web content 30 and associates the hyperlinks with the ID or filename of the graphic 80. When this is complete, a transmitter 52 transmits graphic 80 and associated hyperlinks 78 via wireless network 14 to Client Content Viewer 60 on mobile station 12.

Processor 46 may choose which web page constituents are to be rendered in graphic form, and which of the hyperlinks 78 to transmit in association with graphic 80. For instance, the web page contents may comprise advertising pop-ups, meta-tag information, or hyperlinked text that when rendered as a small graphic, would be extremely small. To this end, processor 46 operates according to policies that, for instance, specify whether to filter pop-ups out or render them as overlaid images, or to eliminate hyperlinks that, if rendered, would be smaller than a predefined size.

Scaling may be done using standard methods within proxy gateway/NAT service 18 or server 28 or anywhere else as appropriate in the path between mobile station 12 and the content provider. Some of the known image scaling methods include Java class image scaling methods, bicubic interpolation scaling, the bilinear scaling method, radial basis functions (RBF) interpolation, scalable vector graphics (SVG) or one of another possible range of raster, vector MPEG or JPEG scaling methods.

A Client Content Viewer 60 on mobile station 12 receives graphic 80 and its associated hyperlinks 78, and, via a graphic rendering component 62 sends graphic 80 to a display buffer (not shown) for display on a screen 70 of mobile station 12. Via a link interface component 64, Client Content Viewer 60 then provides a user of mobile station 12 with the option of selecting one or more of the hyperlinks 78 via a pop-up menu or the like. It will be understood that mobile station 12 is required only to request a web page 30 and receive graphic 80. To display the web content, it is not required to receive an entire HTML web page and make further HTTP requests to retrieve the constituent elements of the particular web page 30 across the mobile device connection. Content Delivery Server 38 handles retrieving the web page and its constituent elements across what would typically be a higher bandwidth connection, rendering the page as a graphic 80 and sending the graphic 80 to Client Content Viewer 60.

As suggested above, while hyperlinks 78 sent with graphic 80 may provide a user the option to navigate, in some cases graphic 80 will contain a rendering of text or other information that is too small for the user of mobile station 12 to read or take action on (fill out a form etc.). To this end, the following sets forth how Client Content Viewer 60 provides a user with the ability to “zoom-in” on a portion of the web page.

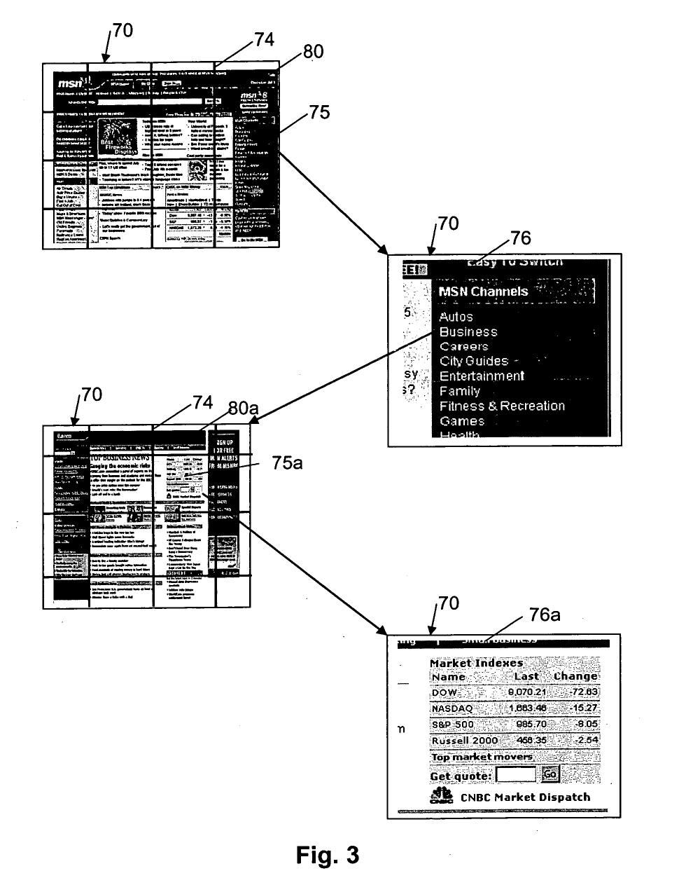

With reference to FIG. 3, a pictorial view showing exemplary steps of web content retrieval according to the preferred embodiment of the invention is shown. A user can toggle on/off a 4×4 grid 74 over top of graphic 80 when displaying graphic 80 on screen 70. Mobile station screen 70 is shown displaying graphic 80, while grid 74 defines a 4×4 subdivision of graphic 80 into portions 75. As can be seen, graphic 80 has been subdivided by Client Content Viewer 60 into sixteen portions 75. If the user selects the eighth portion 75 (as shown), a second request is initiated to retrieve a corresponding portion 76 of web page 30. This second request will contain an identification of the portion such as the coordinates of portion 76 in the graphic 80, or, if there is a predetermined/standard agreement between the Client Content Viewer 60 and Content Delivery Server 38, a portion number. The second request is received by receiver 40 of Content Delivery Server 38, which initiates the retrieval of the corresponding portion 76 of web page 30 by processor 46. Processor 46 then forwards the portion 76 to transmitter 52 for transmittal to Client Content Viewer 60. Client Content Viewer 60 receives and displays portion 76 as a web page (not a graphic) via web page rendering component 66. As one would be able to do with a typical web page in a browser, a user may then perform any action on the portion 76 as though it were the full web page 30, limited only by the input interface of mobile device 12. As shown in FIG. 3, one of those actions may be to select a hyperlink on portion 76.

When a user selects a hyperlink on portion 76, a corresponding request is sent to Content Delivery Server 38 for the web content. As described above, Content Delivery Server 38 returns a corresponding graphic, which Client Content Viewer 60 accordingly subdivides and displays (80a) on screen 70. A further request to Content Delivery Server 38 for a portion 76a of the new page is initiated upon selection of portion 75a of displayed graphic 80a. Portion 76a is returned to Client Content Viewer 60 and displayed via web page rendering component 66, as would be a typical web page, on screen 70.

By transmitting the requested content in two steps, the user is provided with an accurate view of an entire web page, but has the option of “zooming in” on a region of the requested page in order to view it or perform an action on it. No HTML-to-WML transcoding of the web page is required and there is no requirement to create and store both an HTML and a WML page for the same content.

With reference again to FIG. 2, typical web content 30 may be divided into the two general classes of passive content 34 and active content 36. To provide increased performance upon receipt of a request, passive content 34, which generally includes information that can be directly rendered such as basic text drawings and frames, might be retrieved by Content Delivery Server 38 prior to receipt of a request. When such a request is received by Content Delivery Server 38, it need only retrieve active content 36, such as embedded scripts and links, to render the completed web page 30 as graphic 80.

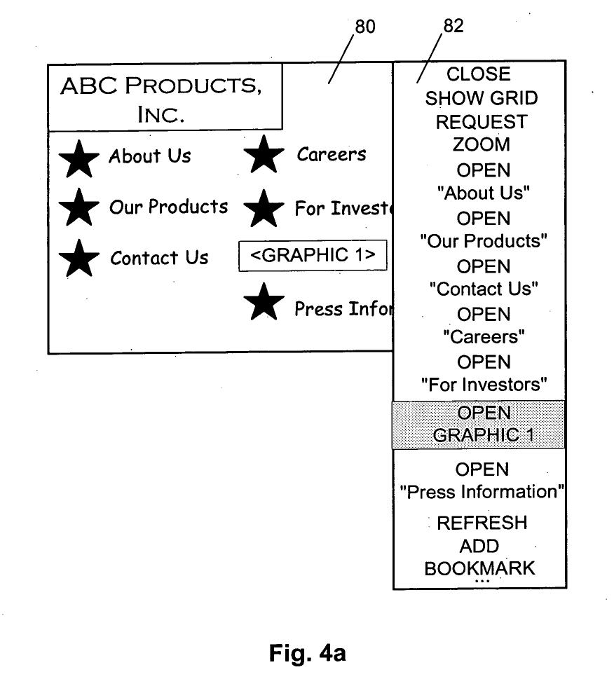

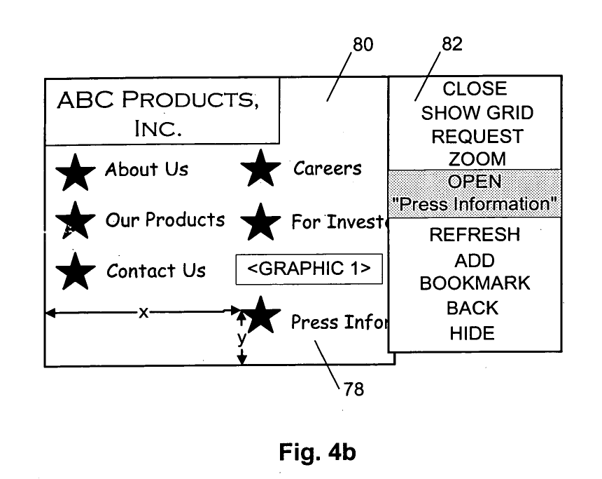

As previously stated, hyperlinks 78 can be sent in association with graphic 80 to Client Content Viewer 60 which can, in turn, provide a user with the ability to initiate requests by selecting one of hyperlinks 78. FIG. 4a is a block diagram showing how a user may select embedded links or download particular aspects of web content. All hyperlinks 78 for displayed graphic 80 are shown in a single menu 82. As set forth above, Content Delivery Server 38 collects hyperlinks 78 from web page 30 and associates hyperlinks 78 with the ID or filename of the graphic, for transmitting to Client Content Viewer 60. All or some of the hyperlinks 78 are sent along with graphic 80, and may be selected by the user at any time.

To increase performance, a web page graphic 80 and its associated hyperlinks 78 are cached by Content Delivery Server 38 so that a subsequent request will result in the immediate delivery of a corresponding graphic 80. This function behaves similarly to proxy servers in typical web service environments. In addition, Client Picture Viewer 60 saves the date and time of receipt of graphic 80 and sends it to Content Delivery Server 38 for checking changes in content, as is typical of caching in wireless environments.

FIG. 4b is a block diagram showing an alternative way of enabling a user to select embedded links or download particular aspects of web content when a Client Content Viewer 60 is displaying a graphic 80 of a web page 30. Screen 70 displays graphic 80, with hyperlinks 78. In this embodiment, hyperlinks 78 have been associated by Content Delivery Server 38 with particular coordinates of graphic 80. Using graphical methods such as those found in Scalable Vector Graphics (SVG), the X and Y coordinates of a mouse or cursor on screen 70 can be determined by Client Picture Viewer 60. This enables a user to position a mouse or cursor over points in the graphic to display a menu 82 having the option of selecting a corresponding hyperlink 78 or other active section of the page. When the user's mouse or cursor passes over a particular coordinate corresponding to a particular hyperlink 78 associated with that coordinate, menu 82 pops up and the user can select that hyperlink. It will be understood that the additional flexibility provided by this embodiment affords the user the ability to select links 78 without having to select a portion 75 of the graphic.

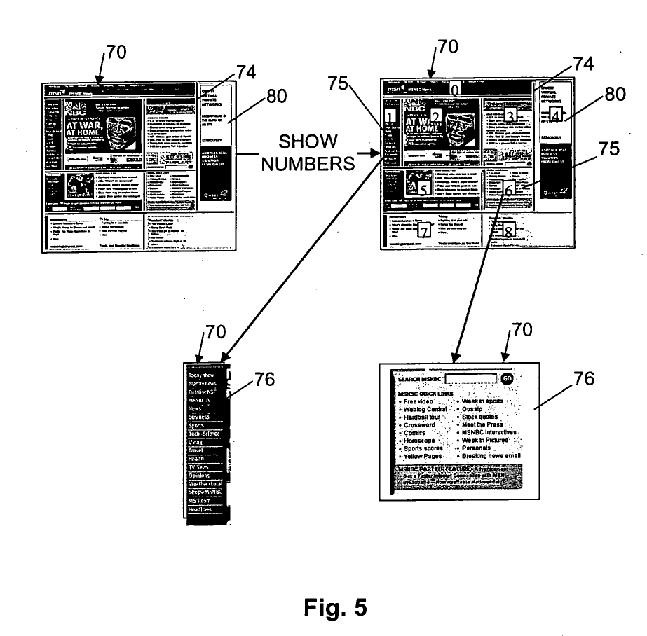

With reference to FIG. 5, a pictorial view showing steps of web content retrieval according to an alternate embodiment of the invention is shown. As can be seen, grid 74 defining graphic portions 75 is established by the Content Delivery Server 38 (not Client Content Viewer 60) based on an aspect of the web page content 30—in particular its frames. In this case, subdivision information is transmitted in association with graphic 80 to Client Content Viewer 60, which is relieved of having to subdivide graphic 80. This alternative enables hyperlinks 78 to be associated with respective such portions 75, so that a user of mobile device 12 has the option of viewing only those hyperlinks 78 that are from a particular portion 76 of a page 30, without the requirement of client content viewer 60 having to track x-y coordinates. Also shown in FIG. 5 is the effect of an ON/OFF toggle of portion numbers, for viewing and selecting by a user. The ON/OFF toggle may be enabled through a keystroke, mouse movement, menu selection, touch screen activity or some other user input method.

Many concepts described herein with reference to the preferred embodiment and other examples are generally applicable to retrieval of picture files from server 28, for instance. In this example, a requested graphic file is simply scaled using one of the aforementioned methods and delivered to Client Content Viewer 60. A grid 74 as described is overlaid based on one of a predetermined subdivision agreement, an aspect of the graphic itself or a set of coordinates. In order to zoom in, a user chooses a portion 75, triggering Content Delivery Server to process or retrieve a portion of graphic file sized for display on screen 70 of mobile station 12. Client Content Viewer 60 in this case does not need to display formatted content at all. In association with the scaled graphic or portion 75 thereof, subdivision information may be sent to Client Content Viewer 60 so it can enable a user to select one of the portions 75. It is also conceivable that hybrid web-linkable graphics may be transmitted such the Client Content Viewer 60 need only display a graphic or portion thereof (rather than a portion of an actual web page), but enable the user to select hyperlinks based on the graphic or a particular portion.

When a portion 75 is transmitted to Client Content Viewer 60, it may also have transmitted in association an identification of its own subdivisions/portions, for continued zooming in. This depends of course on the original size of the graphic file and the extent to which such a service may be offered.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact operation illustrated and described, and accordingly all suitable modifications and equivalents may be resorted to, falling within the purpose and scope of the invention.

For example, when transmitting graphic 80 of a web page to Client Content Viewer 60, the HTML data for the web page and its constituent elements can coincidentally be sent in association with graphic 80. Then, if a user selects a portion of graphic 80 to initiate a request to retrieve a corresponding portion 76 of the web page 30, the HTML data coincidentally sent with graphic 80 can be used by Client Content Viewer 60 to provide a user with the corresponding web page portion 76, without initiating an additional request across network 14.

As set forth above, when subdivisions of graphic 80 of a web page are established by Content Delivery Server 38, they may be established in accordance with an aspect of the web page itself (such as its frames as described above, tables or sections). Alternatively, subdivisions may be established by Content Delivery Server 38 in the form of a grid or according to some other criterion as described above by Client Content Viewer 60.

While Content Delivery Server 38 has been described as operating on proxy gateway/NATs 18 or private Intranet proxy gateway 24, it will be understood that it may be operated on server 28, or at another advantageous point in the path between server 28 and requesting mobile device 12. It is advantageous, however, that Content Delivery Server 38 be supported by functions enabling Content Delivery Server 38 to ascertain the size of the mobile device screen 70 so that graphic 80 is rendered in the appropriate size.

It will be understood that the methods disclosed herein are applicable for use with formatting languages other than HTML, such as the others described earlier in this document. As would be understood by one of ordinary skill in the art, each language will have its own rules for rendering, and must be handled in accordance with those rules. For instance, with XML content there can also be Document Type Definition (DTD) to be fetched that describes the tags used by XML to render a document.

What is claimed is:

1. A method of transmitting formatted data to a requestor, the method comprising:
retrieving a page of formatted data;
rendering said page as a graphic sized for display by said requester; and
in response to a request from said requester for said page, transmitting said graphic to said requester.

2. The method of claim 1, wherein said retrieving is done in response to said request for said page.

3. The method of claim 1, further comprising:
receiving an additional request for a portion of said page; and
transmitting said portion of said page in response to said additional request.

4. The method of claim 3, wherein said additional request includes graphic coordinates corresponding to said portion of said page.

5. The method of claim 3, wherein said additional request includes a predetermined identification of said portion of said page.

6. The method of claim 1, further comprising:
subdividing said graphic into portions;
in association with said graphic, transmitting an identification of said portions to said requestor.

7. The method of claim 6, wherein said subdividing is determined in accordance with an aspect of said page.

8. The method of claim 1, further comprising:
in association with said graphic, transmitting at least one hyperlink in said page to said requestor.

9. The method of claim 6, further comprising:
in association with said identification of said portions, transmitting hyperlinks in corresponding portions of said page to said requestor.

10. The method of claim 1, further comprising:
in association with said graphic, transmitting said page to said requester in response to said request.

11. A method of displaying formatted data, comprising:
requesting a page of formatted data from a server;
in response to said request, receiving a graphic rendering of said page from said server; and
displaying said graphic.

12. The method of claim 11, further comprising:
selecting a portion of said graphic;
initiating a second request for a portion of said page corresponding to said portion of said graphic;
in response to said second request, receiving said portion of said page; and
displaying said portion of said page.

13. The method of claim 11, further comprising:
in association with said graphic, receiving at least one hyperlink in said page;
providing a user with an option to select said at least one hyperlink; and
in response to a selection by said user, initiating a request for corresponding formatted content.

14. A method of transmitting a graphic file to a requester, the method comprising:
retrieving a graphic file;
scaling said graphic file for display by said requestor;
subdividing the scaled graphic file into portions;
in response to a request from said requestor for said graphic file, transmitting the scaled graphic file and an identification of said portions to said requester.

15. The method of claim 14, wherein said subdividing is determined in accordance with an aspect of said graphic file.

16. The method of claim 14, further comprising:
in association with said graphic, transmitting at least one hyperlink to said requestor.

17. The method of claim 14, further comprising:
in association with said identification of said portions, transmitting hyperlinks to said requestor.

18. The method of claim 14, further comprising:
receiving an additional request for a portion of said graphic file;
transmitting said portion of said graphic file to said requester in response to said additional request.

19. A method of displaying a graphic file, comprising:
requesting said graphic file from a server;
in response to said request, receiving said graphic file scaled for display and an identification of portions of said graphic file; and
displaying said graphic file and an overlaid grid corresponding to said identification of portions of said graphic file.

20. The method of claim 19, further comprising:
using said grid, selecting a portion of said graphic file;
requesting said portion of said graphic file from said server;
receiving said portion sized for display; and
displaying said portion.

21. The method of claim 20, wherein said portion sized for display is received with an identification of portions of said portion for displaying another overlaid grid over said portion.

22. The method of claim 19, wherein at least one hyperlink is received in association with corresponding said portions of said graphic file and said at least one hyperlink is selectable upon selection of a corresponding portion of said graphic file.
